(19) United States
(12) Patent Application Publication
(10) Pub. No.: US 2008/0192497 A1
(43) Pub. Date: Aug. 14, 2008

(54) Warning light device of a bicycle

(76) Inventor: Kung-Fu Chao, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 11/704,383

(22) Filed: Feb. 9, 2007

(51) Int. Cl. B62J 6/00

(52) U.S. Cl. 362/473

(57) ABSTRACT

A warning light device of a bicycle includes a seat tube having an opening, a shell base installed in the opening, a warning light, a power unit and a waterproof unit. The warning light is set in a recess of the shell base, with the power unit stored in a cell room of the shell base, connected with the warning light. The waterproof unit is installed between the shell base and the warning light. Therefore, not only the warning light can be easily assembled in and disassembled from the shell base of the seat tube, but also the circuit board can be protected from damaged by water.

### BACKGROUND OF THE INVENTION

1. Field of the Invention

This invention relates to a bicycle, particularly to one having a warning light device that can be easily assembled in and disassembled from a seat tube, with a waterproof effect.

2. Description of the Prior Art

As shown in FIG. 1, a conventional warning light 10 of a bicycle is composed of a hollow seat tube 11, a radiating member 12 and a positioning member 13. The seat tube 11 is provided with a slot 111 cut longitudinally. The radiating member 12 is installed in the seat tube 11, facing toward the slot 111 to shine out thereof. The positioning member 12 is provided with a bolt 131 used to keep the radiating member 12 restrictively fixed, a supporting rod 132 extended downwards from the radiating member 12 and a positioning plug 133 fixed at the lower end of the seat tube 11. But, in case that the radiating member 12 is out of work, the seat tube 11 has to be disassembled first and them, the bolt 131 and the positioning member 13 must as well be disassembled to maintain or replace the radiating member 12, causing a very complicated procedure. Of course, a reverse identical complicated procedure has to be done to assemble them again

### SUMMARY OF THE INVENTION

he objective of this invention is to offer a warning light device of a bicycle.

The main characteristics of the invention are a seat tube having an opening, a shell base installed in the opening, a warning light, a power unit and a waterproof unit. The warning light is set in a recess of the shell base, while the power unit is stored in a cell room of the shell base, connected with the warning light. The waterproof unit is installed between the shell base and the warning light to prevent water from permeating into a circuit board of the warning light. Therefore, the warning light can be easily assembled in and disassembled from the shell base of the seat tube, and the circuit board can be protected from damaged by water.

### BRIEF DESCRIPTION OF DRAWINGS

This invention is better understood by referring to the accompanying drawings, wherein:

FIG. 1 is a cross-sectional view of a conventional warning light device of a bicycle;

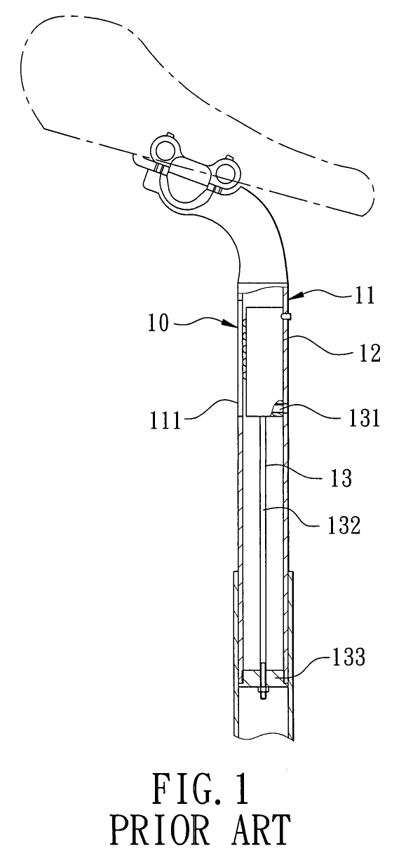

FIG. 2 is a perspective view of a first preferred embodiment of a warning light device of a bicycle in the present invention;

FIG. 3 is an exploded perspective view of the first preferred embodiment of a warning light device of a bicycle in the present invention;

FIG. 4 is a side view of the first preferred embodiment of a warning light device of a bicycle in the present invention;

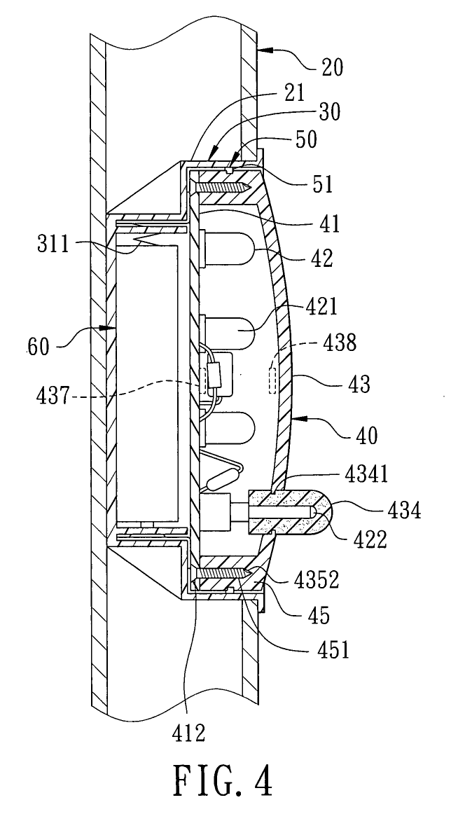

FIG. 5 is another side view of the first preferred embodiment of a warning light device of a bicycle in the present invention;

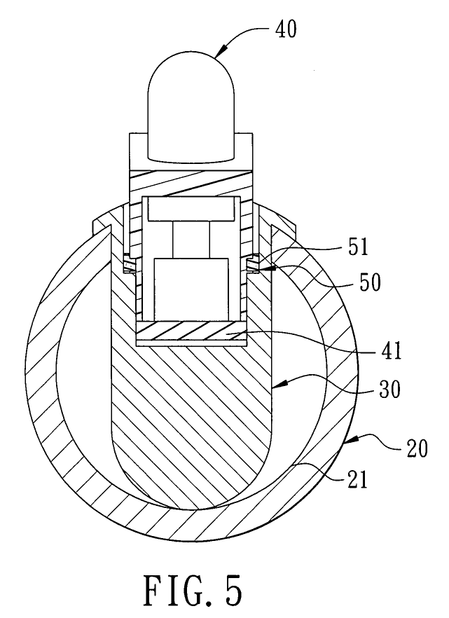

FIG. 6 is a side view of the first preferred embodiment of a warning light device of a bicycle in the present invention, showing a warning light being disassembled from a seat tube; and

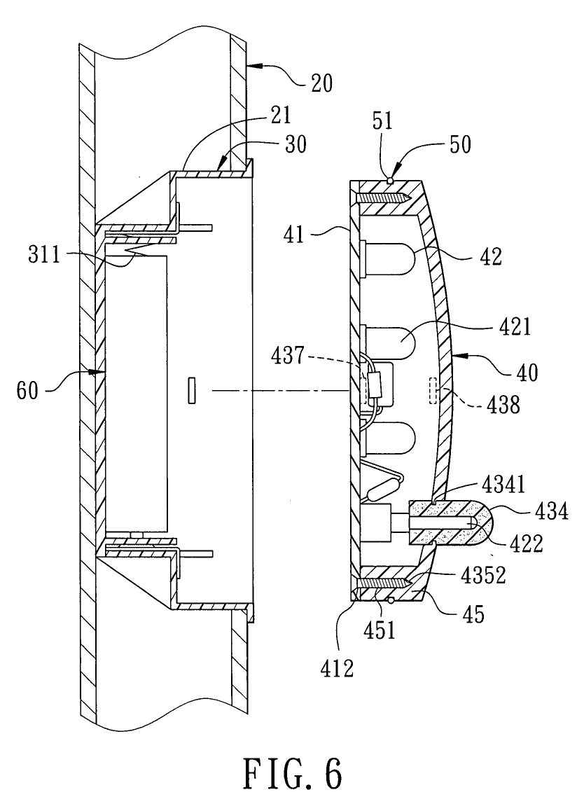

FIG. 7 is a side view of a second preferred embodiment of a warning light device of a bicycle in the present invention.

### DETAILED DESCRIPTION OF THE PREFERRED EMBODIMENT

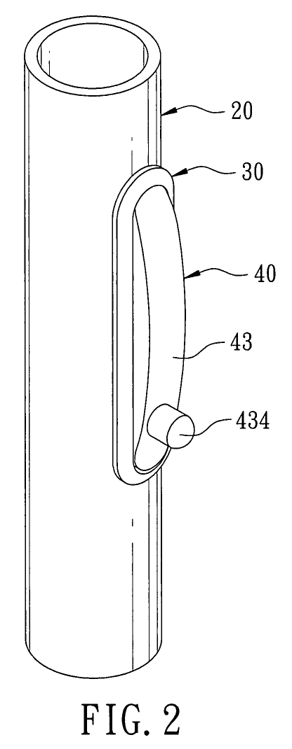

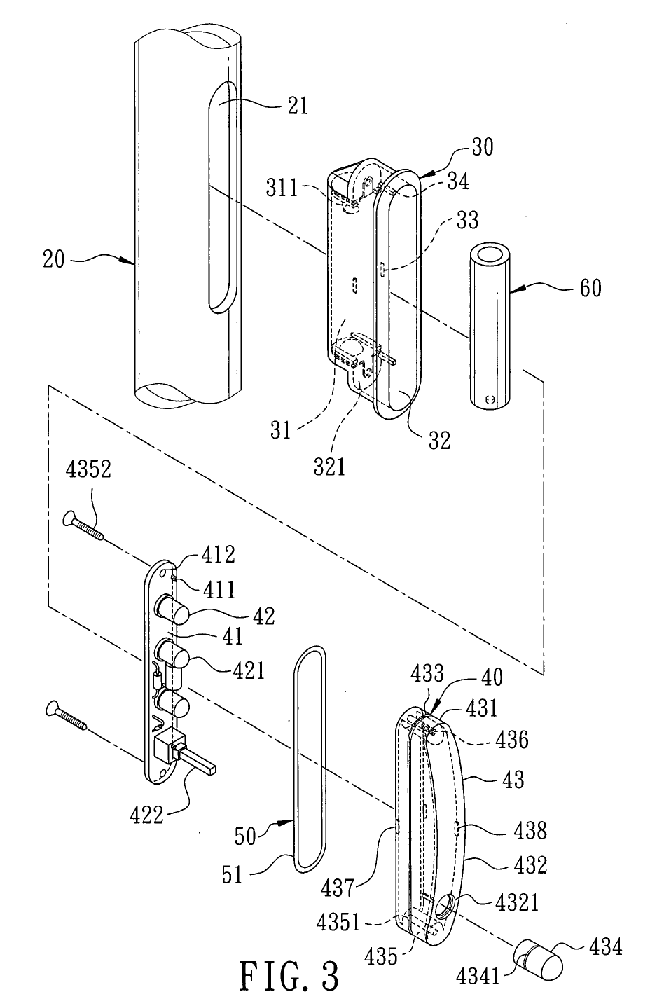

As shown in FIGS. 2 and 3, a first preferred embodiment of a warning light device of a bicycle in the present invention is composed of a seat tube 20, a shell base 30, a warning light 40, a waterproof unit 50 and a power unit 60.

The seat tube 20 formed hollow is provided with an opening 21 cut longitudinally.

The shell base 30 made of plastic material is formed to have a shape similar to that of the opening 21 so as to be elastically fitted in it. The shell base 30 consists of a cell room 31 and a recess 32. The cell room 31 is provided with a conducting element 311 located correspondingly at its two ends respectively. The recess 32 is formed above the cell room 31, provided with a supporting stage 321 located correspondingly at two ends of its bottom respectively. In addition, the shell base 30 is also provided with a locking projection 33 extruded correspondingly at two sides of the recess 32 respectively, and a positioning bar 34 projected correspondingly at its two ends respectively.

The warning light 40 installed in the recess 32 is composed of a circuit board 41, a radiating unit 42 and a cover 43.

The circuit 41 is laid on the supporting stages 321 of the shell base 30, provided with a slot 411 located at a position corresponding to each of the positioning bars 34 and a hole 412 bored at its two ends respectively.

The radiating unit 42 is fixed on the top of the circuit board 41, consisting of a preset number of light radiators 421 and a switch 422. The light radiators 421 are LEDs and the switch 422 functions mechanically.

The cover 43 put on the top of the circuit 41 is provided with an annular wall 431 built around its circumference, a light-previous member 432 that is set to face to the radiating unit 42 and bored with a hole 4321 for fitting the switch 422, and a ditch 433 cut around the outer edge of the annular wall 431. The cover 43 is additionally provided with a hollow rubbery plug 434 to be inserted through the hole 4321 to mount on the switch 422 and positioned in the hole 4321 via a locking groove 4341 dug annularly to bite the rim of the hole 4321, a fixing portion 435 located at its ends respectively to have a threaded hole 4351 and a positioning slot 436 concaved at two ends of the outer surface of the annular wall 431 respectively adjacent to the slot 411 exactly. Moreover, provided in the cover 43 are two locking grooves 437 respectively cut at a location corresponding to the locking projection 33, and a projection 438 extruded right above one of the locking grooves 437.

The waterproof unit 50 is formed as an 0-shaped ring 51, fitted in the ditch 433 to be slightly extended out of the circumference of the cover 43.

The power unit 60 is composed of a battery, installed in the cell room 31 of the shell base 30 to connect with the conducting elements 311 that are connected with the circuit board 41 of the warning light 40.

In assembly, as shown in FIGS. 3˜6, insert two screws 4352 through the holes 412 of the circuit board 41 to screw fixedly in the threaded holes 4351. Assemble all components of the warning light 40 together, and put the battery of the power unit 60 in the cell room 31 of the shell base 30. Next, keep the slots 411 and the positioning slots 436 fitted with the positioning bars 34 and the locking grooves 437 engaged with the locking projections 33, enabling the warning light 40 easily assembled in the recess 32 of the shell base 30. On the contrary, by leaning a finger on the projection 438, the warning light 40 can be smoothly disassembled from the shell base 30. The O-shaped ring 51 laid between the shell base 30 and the warning light 40 can prevent water from permeating into the circuit board 41. The rubbery plug 434 is able to keep water from entering the circuit board, too. Further, the light radiators 421 of the radiating unit 42 can be turned on via just pressing the switch 422.

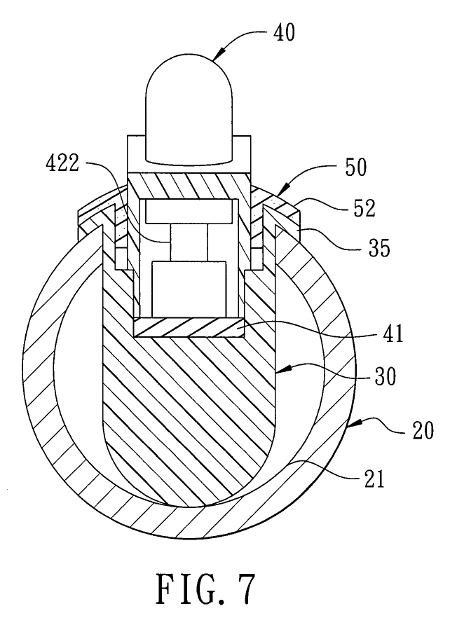

As shown in FIG. 7, a second preferred embodiment of a warning light device of a bicycle in the present invention has almost the same components as the first one does, except what is described below. The shell base 30 is provided with an annular projected rim 35 extruded around its upper edge. The waterproof unit 50 is formed as a waterproof packing 52 attached on the annular projected rim 35 and installed between the shell base 30 and the warning light 40 to prevent water from permeating into the circuit board 41. In addition, the switch 422 is a light-activated switch, able to turn on/off itself depending on the condition of the weather.

The invention has the following advantages as can be seen from the foresaid description.

1. The warning light 40 can be easily assembled and installed in the shell base 30, enabling a user to assemble or disassemble it easily and conveniently.

2. Installed with the waterproof unit 50 and the rubbery plug 434, the circuit board 41 can be kept from damaged by water entering from the outside, lessening disorder probability, and beneficial to effectively prolong its service life.

While the preferred embodiment of the invention has been described above, it will be recognized and understood that various modifications may be made therein and the appended claims are intended to cover all such modifications that may fall within the spirit and scope of the invention.

What is claimed is:

1. A warning light device of a bicycle comprising:
a seat tube formed hollow and provided with an opening cut longitudinally;
a shell base formed to have a shape similar to that of said opening so as to be fitted therein, and provided with a recess concaved downward along its edge;
a warning light installed in said recess and composed of a circuit board, a radiating unit and a cover, said radiating unit fixed on a top of said circuit board, said cover closed above said radiating unit and provided with an annular wall built around its circumference and a light-previous member facing exactly to said radiating unit;
a waterproof unit installed between said shell base and said warning light; and
a power unit installed in said shell base and connected with said circuit board.

2. A warning light device of a bicycle as claimed in claim 1, wherein said radiating unit consists of a preset number of light radiators and a switch.

3. A warning light device of a bicycle as claimed in claim 2, wherein said light-previous member of said cover is bored with a hole for said switch to pass through, which is a mechanical one.

4. A warning light device of a bicycle as claimed in claim 2, wherein said switch is a light-activated switch.

5. A warning light device of a bicycle as claimed in claim 3, wherein said cover is provided with a hollow rubbery plug that is dug annularly with a locking groove to bite a rim of said hole so as to keep said rubbery plug positioned in said hole.

6. A warning light device of a bicycle as claimed in claim 1, wherein said power unit is a battery accommodated in a cell room provided in said shell base to be located under said recess, said shell base also provided with two supporting stages located at two ends of a bottom of said recess respectively for locating said warning light.

7. A warning light device of a bicycle as claimed in claim 1, wherein said shell base is provided with a locking projection extruded correspondingly at two sides of said recess respectively, and said cover of said warning light is provided with two locking grooves for locking with said locking projections while installing said warning light into said shell base.

8. A warning light device of a bicycle as claimed in claim 1, wherein said cover is provided with a fixing portion located at its ends respectively to have a threaded hole and said circuit board is provided with a hole bored at a location corresponding to each of said threaded holes so as to insert a screw to keep said warning light fixed on said shell base.

9. A warning light device of a bicycle as claimed in claim 1, wherein said annular wall of said cover is provided with a ditch cut around its outer edge and said waterproof unit is an O-shaped ring fitted in said ditch.

10. A warning light device of a bicycle as claimed in claim 1, wherein said shell base is provided with an annular projected rim extruded around its upper edge.

11. A warning light device of a bicycle as claimed in claim 10, wherein said waterproof unit is a waterproof packing attached on said annular projected rim.

12. A warning light device of a bicycle as claimed in claim 1, wherein said shell base is provided with a positioning bar projected at its two ends respectively, said cover provided with a positioning slot cut at two ends of an outer surface of said annular wall respectively to correspond to said positioning bar, said circuit board also provided with a slot located at a position adjacent to said positioning slot to correspond to each of said positioning bars, so that said positioning slots and said slots are fitted in said positioning bars restrictively.
